(19) United States
(12) Patent Application Publication
(10) Pub. No.: US 2016/0224940 A1
(43) Pub. Date: Aug. 4, 2016

(54) Word Cloud Analysis System

(71) Applicant: ADP, LLC, Roseland, NJ (US)

(72) Inventor: Keith Wilson Fulton, South Orange, NJ (US)

(21) Appl. No.: 14/613,487

(22) Filed: Feb. 4, 2015

(51) Int. Cl. G06Q 10/10

(52) U.S. Cl. CPC G06Q 10/1053

(57) ABSTRACT

A method for managing characteristics in word clouds. A computer system displays a graphical display of words representing first characteristics in the characteristics for a first person in a word cloud in a graphical user interface on a display system in the computer system. The graphical display of the words represents the first characteristics with first values that distinguish the first person from a second person with second characteristics with second values. The computer system also changes a value in the first values for a characteristic in the first characteristics when a user input is received through the graphical user interface in which the user input changes the graphical display of a word in the words corresponding to the characteristic.

### CROSS-REFERENCE TO RELATED APPLICATION

This application is related to the following patent application: entitled “Task Management System”, attorney docket no. ES2014040.2; filed even date herewith, assigned to the same assignee, and incorporated herein by reference.

### BACKGROUND INFORMATION

1. Field

The present disclosure relates generally to an improved data processing system. In particular, the present disclosure relates to a method and apparatus for visualizing skills in an organization. Still more particularly, the present disclosure relates to a method and apparatus for a graphical user interface used in visualizing and managing skills for employees of an organization.

2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance, wellness plans, and other programs and organizations using an employee information system. As yet another example, an information system may be used to determine when to hire new employees, assign employees to projects, perform reviews for employees, and other suitable operations for the organization.

Currently used information systems include a database of records. These records may be searched and viewed to perform various operations within an organization. However, these types of records in currently used databases may be cumbersome and difficult to read. As a result, errors may occur in reading the records and more time than desired may be needed to obtain information from a database in an information system.

Therefore, it would be desirable to have a method and apparatus that take into account at least some of the issues discussed above, as well as other possible issues. For example, it would be desirable to have a method and apparatus that overcome issues with comprehending information in records for people in a database.

### SUMMARY

In one illustrative embodiment, a method for managing characteristics in word clouds is presented. A computer system displays a graphical display of words representing first characteristics in the characteristics for a first person in a word cloud in a graphical user interface on a display system in the computer system. The graphical display of the words represents the first characteristics with first values that distinguish the first person from a second person with second characteristics with second values. The computer system changes a value in the first values for a characteristic in the first characteristics when a user input is received through the graphical user interface in which the user input changes the graphical display of a word in the words corresponding to the characteristic.

In another illustrative embodiment, a computer system comprises a display system and a word cloud generator in the computer system in communication with the display system. The word cloud generator displays a graphical display of words representing first characteristics in characteristics for a first person in a word cloud in a graphical user interface on the display system in the computer system. The graphical display of the words represents the first characteristics with first values that distinguish the first person from a second person with second characteristics with second values. The word cloud generator changes a value in the first values for a characteristic in the first characteristics when a user input is received through the graphical user interface in which the user input changes the graphical display of a word in the words corresponding to the characteristic.

In yet another illustrative embodiment, a computer program product for managing characteristics in word clouds comprises a computer readable storage media, and first program code and second program code stored on the computer readable storage media. The first program code displays a graphical display of words representing first characteristics in the characteristics for a first person in a word cloud in a graphical user interface on a display system in the computer system. The graphical display of the words represents the first characteristics with first values that distinguish the first person from a second person with second characteristics with second values. The second program code changes a value in the first values for a characteristic in the first characteristics when a user input is received through the graphical user interface in which the user input changes the graphical display of a word in the words corresponding to the characteristic.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an information environment in accordance with an illustrative embodiment;

FIG. 2 is an illustration of data flow occurring when comparing characteristics in accordance with an illustrative embodiment;

FIG. 3 is an illustration of a block diagram illustrating interaction between word clouds in accordance with an illustrative embodiment;

FIG. 4 is an illustration of a graphical user interface with a word cloud in accordance with an illustrative embodiment;

FIG. 5 is an illustration of a graphical user interface with a control to manipulate a word in a word cloud in accordance with an illustrative embodiment;

FIG. 6 is an illustration of a graphical user interface with a change in a graphical display of a word in accordance with an illustrative embodiment;

FIG. 7 is an illustration of a change in a graphical display of words in a word cloud in accordance with an illustrative embodiment;

FIG. 8 is an illustration of a graphical user interface with a change in a graphical display of words in a word cloud in accordance with an illustrative embodiment;

FIG. 9 is an illustration of a graphical user interface with word clouds for multiple people in accordance with an illustrative embodiment;

FIG. 10 is an illustration of a graphical user interface in which skills in word clouds are combined in accordance with an illustrative embodiment;

FIG. 11 is an illustration of a graphical user interface with a word cloud and a job description in accordance with an illustrative embodiment;

FIG. 12 is an illustration of a graphical user interface showing a word cloud generated from the difference between two word clouds in accordance with an illustrative embodiment;

FIG. 13 is an illustration of a graphical user interface for importing word clouds in accordance with an illustrative embodiment;

FIG. 14 is an illustration of a graphical user interface displaying word clouds that have been imported in accordance with an illustrative embodiment;

FIG. 15 is an illustration of a graphical user interface for performing functions on word clouds in accordance with an illustrative embodiment;

FIG. 16 is an illustration of a graphical user interface displaying a word cloud generated from a function performed on word clouds in accordance with an illustrative embodiment;

FIG. 17 is an illustration of a graphical user interface for performing functions on word clouds in accordance with an illustrative embodiment;

FIG. 18 is an illustration of a graphical user interface displaying a word cloud generated from a function performed on word clouds in accordance with an illustrative embodiment;

FIG. 19 is an illustration of a graphical user interface for defining one or more functions to perform on word clouds in accordance with an illustrative embodiment;

FIG. 20 is an illustration of a flowchart of a process for managing characteristics in word clouds in accordance with an illustrative embodiment;

FIG. 21 an illustration of a flowchart of a process for performing a comparison of characteristics between two people in accordance with an illustrative embodiment;

FIG. 22 is an illustration of a flowchart of a process for performing a comparison of skills in accordance with an illustrative embodiment;

FIG. 23 is an illustration of a flowchart of a process for performing functions on word clouds in accordance with an illustrative embodiment; and

FIG. 24 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that in assigning people to projects, various characteristics about the people may be used to identify who is most suited for different projects. The characteristics may include, for example, skills and experience that may be considered to identify people with skills and experience that are needed for a project.

The illustrative embodiments recognize and take into account that spreadsheets or reports that present the characteristics about people may be more difficult to compare than desired. The illustrative embodiments also recognize and take into account that changing values for characteristics may be more difficult than desired.

Thus, the illustrative embodiments provide a method and apparatus for managing a database of characteristics. These characteristics are for people in an organization. In particular, the people may be employees in an organization. In one example, a process displays, by a computer system, a graphical display of words representing the characteristics of a first person in a word cloud in a graphical user interface on a display system in the computer system. The graphical display of the words represents values for the characteristics that distinguish the first person from a second person. The process changes, by the computer system, a value in the values for a characteristic in the characteristics when a user input is received through the graphical user interface in which the user input changes the graphical display of a word in the words corresponding to the characteristic in the characteristics.

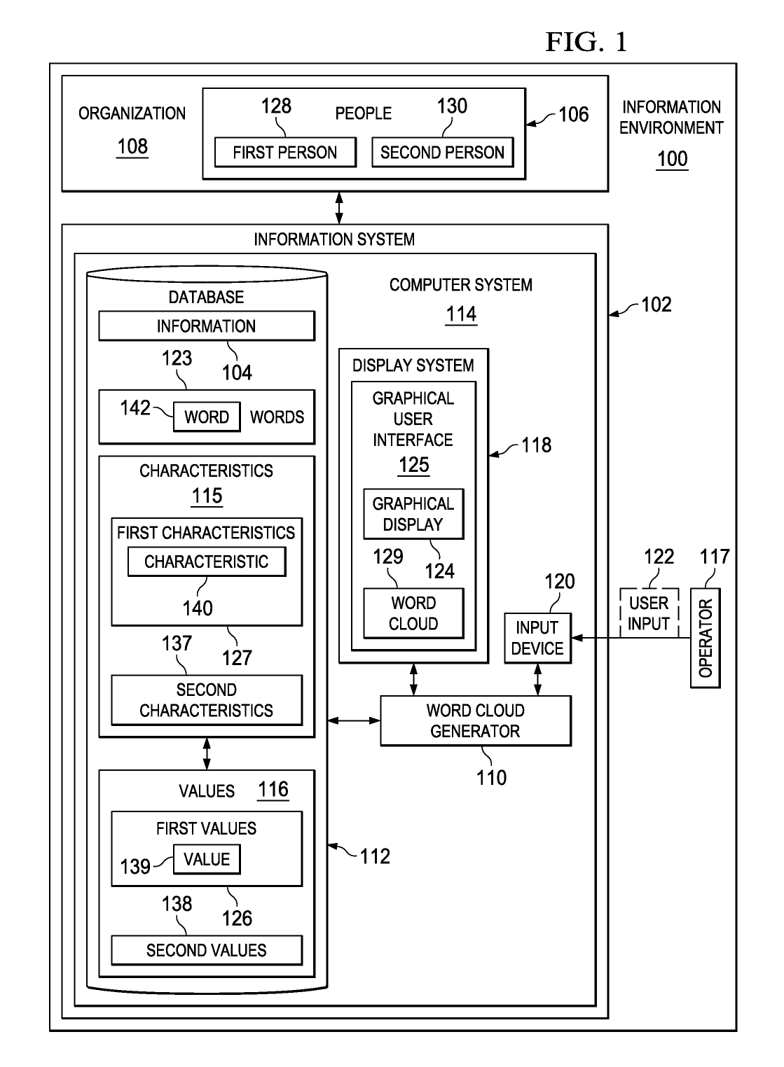

With reference now to the figures, and in particular, with reference to FIG. 1, an illustration of a block diagram of an information environment is depicted in accordance with an illustrative embodiment. In this illustrative example, information environment 100 includes information system 102. Information system 102 manages information 104 about people 106 in organization 108.

Organization 108 may be, for example, a corporation, a partnership, a charitable organization, a city, a government agency, some other suitable type of association, or a subset thereof. People 106 may be employees of organization 108. In other illustrative examples, people 106 may be members of organization 108, without being employees. Information system 102 may be an employee information system or some other type of information system that stores and provides access to information 104 about people 106.

In this illustrative example, information system 102 includes a number of different components. As depicted, information system 102 includes word cloud generator 110 and database 112. Word cloud generator 110 and database 112 may be implemented in computer system 114.

Computer system 114 is a hardware system that includes one or more data processing systems. When more than one data processing system is present, those data processing systems may be in communication with each other using a communications medium. The communications medium may be a network. The data processing systems may be selected from at least one of a computer, a server computer, a tablet, or some other suitable data processing system.

As used herein, the phrase “at least one of,” when used with a list of items, means different combinations of one or more of the listed items may be used and only one of each item in the list may be needed. In other words, “at least one of” means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In this illustrative example, database 112 stores information 104 about people 106. For example, database 112 stores information 104 in the form of characteristics 115 about people 106. Characteristics 115 have values 116. These values may provide a weighting for characteristics 115. Information 104 is in a format that is used by database 112 to store information 104.

Database 112 may take various forms. For example, database 112 may be a relational database, a hierarchical database, or some other suitable type of database. Word cloud generator 110 provides operator 117 with access to database 112. The access may be provided through display system 118 and input device 120 in computer system 114.

Display system 118 is hardware and may include software. In this illustrative example, display system 118 includes one or more display devices. In this illustrative example, display system 118 may be a display device on a workstation, a mobile phone, a tablet, or some other suitable data processing system in computer system 114. Input device 120 may be, for example, selected from one of a keyboard, a trackball, a mouse, a touchscreen in display system 118, or some other suitable type of input device.

As depicted, word cloud generator 110 reads information 104 and displays word clouds on display system 118. Word cloud generator 110 changes the format of information 104 from a first format used to store information 104 to a second format to display information 104 in word clouds on display system 118.

In these illustrative examples, a word cloud is a visual representation of information using words displayed in display system 118. The importance of the words may be represented using font size, color, or other characteristics, for displaying the words.

User input 122 may be received from operator 117 through input device 120 to manipulate word clouds. In particular, user input 122 may manipulate characteristics 115 for words 123 which are displayed on graphical display 124 in graphical user interface 125. In particular, user input 122 may manipulate values 116 for characteristics 115.

For example, word cloud generator 110, identifies first values 126 for first characteristics 127 about first person 128 that distinguishes first person 128 from second person 130 in database 112 in information system 102. As depicted, characteristics 115 may be selected from at least one of a skill, an education level, an interest, a tenure, a name, a work location, a competency, or some other type of characteristic for people 106.

Word cloud generator 110 displays graphical display 124 of words 123 representing first characteristics 127 in characteristics 115 for first person 128 in people 106 in word cloud 129 in graphical user interface 125 on display system 118. Graphical display 124 of words 123 represents first characteristics 127 with first values 126 that distinguish first person 128 from second person 130 having second characteristics 137 with second values 138.

Additionally, word cloud generator 110 changes value 139 in first values 126 for characteristic 140 in first characteristics 127 when user input 122 is received through graphical user interface 125 in which user input 122 changes graphical display 124 of word 142 in words 123 corresponding to characteristic 140. In this manner, operator 117 may graphically change value 139 for characteristic 140.

The change in graphical display 124 of word 142 may be performed in a number different ways. For example, user input 122 may change at least one of a size, an animation, a color, a font, or some other characteristic of word 142 that changes graphical display 124 of word 142.

This type of change of value 139 is in contrast to receiving user input 122 with a value for value 139. This type of change to value 139 is more intuitive as compared to entering values 116.

Additionally, word cloud generator 110 may change graphical display 124 of words 123 for first person 128 to reflect a change in first values 126 for first characteristics 127. In particular, changing value 139 of word 142 may also change the values of other words in words 123. Word cloud generator 110 may change values 116 based on a change in value 139 such that a total of values 116 remains unchanged when value 139 is changed.

For example, first values 126 for words 123 may have a total value that does not change. As result, changing value 139 for word 142 results in first values 126 for other words in words 123 to change. For example, increasing value 139 for word 142 results in first values 126 for other words in words 123 to be decreased. As a result, changing first values 126 based on the change in value 139 is such that a total of first values 126 remains unchanged when value 139 is changed.

In this illustrative example, word cloud generator 110 may be implemented in software, hardware, firmware or a combination thereof. When software is used, the operations performed by word cloud generator 110 may be implemented in program code configured to run on hardware, such as a processor unit. When firmware is used, the operations performed by word cloud generator 110 may be implemented in program code and data and stored in persistent memory to run on a processor unit. When hardware is employed, the hardware may include circuits that operate to perform the operations in word cloud generator 110.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

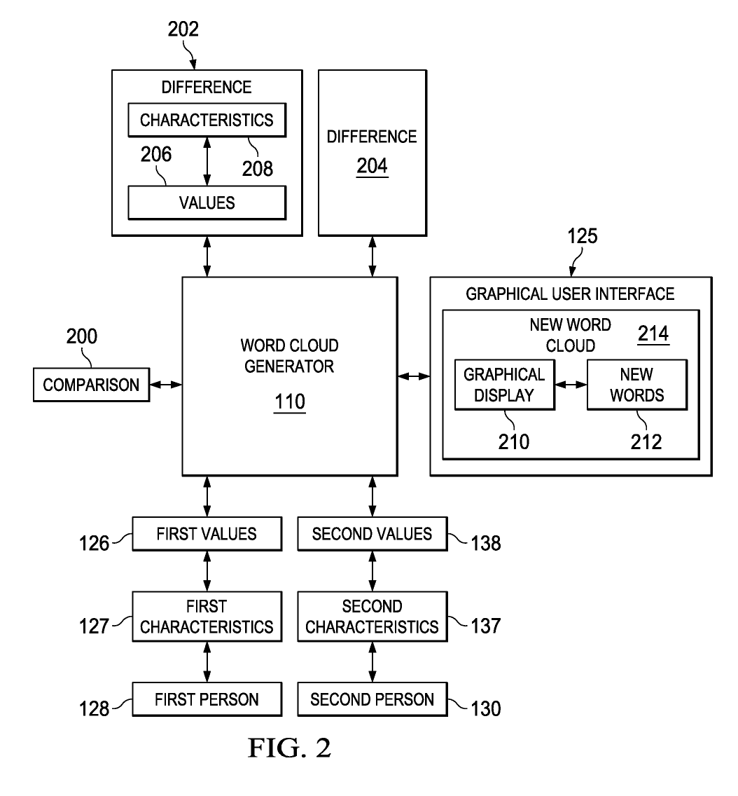

Turning now to FIG. 2, an illustration of data flow occurring when comparing characteristics is depicted in accordance with an illustrative embodiment. The process illustrated in FIG. 2 may be implemented in word cloud generator 110 in FIG. 1.

In this illustrative example, word cloud generator 110 may compare first person 128 and second person 130 to generate comparison 200. In particular, word cloud generator 110 may compare first characteristics 127 for first person 128 and second characteristics 137 for second person 130 to form comparison 200. For example, comparison 200 may be generated by word cloud generator 110 to determine whether second person 130 is able to perform the tasks for the position of first person 128.

As depicted, comparison 200 may be made by subtracting first values 126 for first characteristics 127 for first person 128 and second values 138 for second characteristics 137 for second person 130 to form difference 202. Difference 202 between first values 126 and second values 138 indicates difference 204 between first characteristics 127 for first person 128 and second characteristics 137 for second person 130. In this illustrative example, difference 202 for comparison 200 comprises values 206 for characteristics 208 that correspond to first characteristics 127 and second characteristics 137.

Word cloud generator 110 displays graphical display 210 of new words 212 based on comparison 200 in new word cloud 214 in graphical user interface 125. As depicted, graphical display 210 of new words 212 represents difference 202 between first values 126 for first characteristics 127 for first person 128 and second values 138 for second characteristics 137 for second person 130.

In this depicted example, word clouds for first characteristics 127 and second characteristics 137 may be displayed. This display of words clouds for first characteristics 127 and second characteristics 137 is optional.

In another illustrative example, comparison 200 may be generated by word cloud generator 110 to identify common characteristics between first characteristics 127 and second characteristics 137. For example, if first person 128 and second person 130 have the same duties and perform those duties with a desired level of performance, finding characteristics between first person 128 and second person 130 may be useful in identifying another or an additional person to perform those duties. In this manner, comparison 200 may be used to aggregate skill gaps of people 106 within organization 108 in FIG. 1 for purposes such as finding education classes, mining unused skills for projects and initiatives, searching for candidates to fill a position, creating a new position, or for some other suitable purpose.

Comparison 200 may also be made for reasons other than the ones described above. As another illustrative example, comparison 200 may be a logical comparison in which a logical function is performed between first characteristics 127 and second characteristics 137. For example, if a person is desired to perform tasks that first person 128 and second person 130 perform, a logic function may be performed on first characteristics 127 and second characteristics 137. The presence of a characteristic in at least one of first characteristics 127 and second characteristics 137 is a logic one. The absence of the characteristic in at least one of first characteristics 127 and second characteristics 137 is a logic zero.

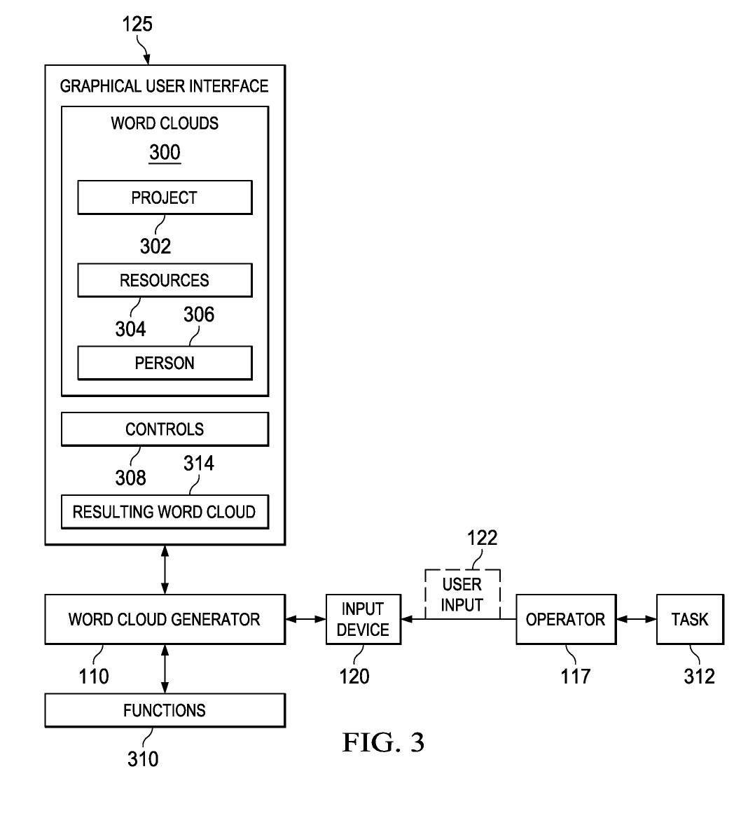

With reference now to FIG. 3, an illustration of a block diagram illustrating interactions between word clouds is depicted in accordance with an illustrative embodiment. In this illustrative example, word cloud generator 110 may be used to manipulate word clouds 300 displayed in graphical user interface 125.

In this illustrative example, word clouds 300 may take various forms. For example, word clouds 300 include at least one of project 302, resources 304, or person 306. As depicted, project 302 is a word cloud with skills needed for a project. Resources 304 is a word cloud that identifies skills that are available for use. Resources 304 may include skills for one person or may be an aggregation of skills for multiple people. Person 306 is a word cloud that identifies characteristics about a person.

As depicted, the manipulation of word clouds 300 is performed by word cloud generator 110 using user input 122 generated by input device 120 operated by operator 117. User input 122 may manipulate controls 302 displayed in graphical user interface 125. The manipulation of controls 308 causes word cloud generator 110 to perform one or more of functions 310 on word clouds 300.

In this illustrative example, functions 310 provide interactions between word clouds 300. These interactions may include, for example, at least one of adding word clouds, subtracting word clouds, or some combination thereof.

In one illustrative example, word cloud generator 110 enables operator 117 to manage task 312. As depicted, word cloud generator 110 may display a graphical display of words 123 for characteristics 115 of people 106 in word clouds 300 in graphical user interface 125. Word cloud generator 110 performs a group of functions 310 on word clouds 300 based on user input 122 to the graphical user interface 125. As used herein, a “group of” when used with reference to items means one or more items. For example, a group of functions 310 is one or more of functions 310.

As depicted, word cloud generator 110 displays resulting word cloud 314 with resulting characteristics that results from performing the group of functions 310 on word clouds 300. In this manner, operator 117 is enabled to manage task 312 using the visualization of at least one of word clouds 300 and resulting word cloud 314 in graphical user interface 125.

For example, an identification of skill gaps for projects may be performed using the following equation:

Resulting Word Cloud=Word Cloud A+Word Cloud B−Word Cloud C.

In this equation, Word Cloud A represents skills needed to perform project A, and Word Cloud B represents skills needed to perform project B. Word cloud C represents resources C, which are skills that are available from one or more people. In this depicted example, resources C are present to perform project A and project B. This equation may be used identify skill gaps that may be present for performing either of project A and project B.

Additionally, functions 310 may include a function that standardizes word clouds. For example, if a first word cloud has more words than a second word cloud in the same equation, a standardization function may be used to drop words in the second word cloud such that the two word clouds have the same number of words. The words dropped may be those that have the lowest weighting.

In the illustrative example, word cloud generator 110 provides a visualization of characteristics 115 on graphical user interface 125 using word clouds 300 that aids operator 117 in performing task 312. For example, the visualization of characteristics 115 using one or more word clouds may be used to perform task 312. In this example, task 312 may be, for example, identifying a skill gap in a position or between people 106 in organization 108. The identification of missing skills or desired skills may be accomplished through comparing the skills using word clouds 300 in the illustrative example. With word clouds 300, operator 117 may visually identify a gap in skills. As another illustrative example, operator 117 may use word clouds to form other tasks such as generating a job description.

In the illustrative examples, computer system 114 in FIG. 1 operates as a special purpose computer system in which word cloud generator 110 in computer system 114 enables changing characteristics displayed in a word cloud by changing a display of one or more words graphically displayed in the word cloud. Word cloud generator 110 enables changing values for characteristics by changing the graphical display of one or more words in a word cloud. For example, a size of a word in a word cloud may be changed by user input. A change in the word cloud generator enables a visualization of changes in a characteristic relative to other characteristics represented by the graphical display of words representing the characteristics in the word cloud.

Word cloud generator 110 enables an intuitive approach to changing values for characteristics by changing the graphical display of the words representing the characteristics. Thus, word cloud generator 110 transforms computer system 114 into a special purpose computer system as compared to currently available general computer systems that do not have word cloud generator 110.

Further, computer system 114 performs a transformation of data within information system 102 in FIG. 1. Information 104 about people 106 stored in a first format in database 112 in FIG. 1 is transformed into a second format for display in graphical user interface 125. In particular, information 104 is in a first format designed for storage in database 112. Word cloud generator 110 transforms information 104 into a second format that allows for graphical display 124 of words 123 in word cloud 129 in graphical user interface.

The function of the second format is for a display of information 104 in graphical user interface 125 on display system 118 in FIG. 1. In contrast, the first format is for storing information 104 in database 112 in FIG. 1. Word cloud generator 110 facilitates the transformation of information 104 between these two formats.

The illustration of information environment 100 and the different components in information environment 100 in FIGS. 1-3 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, word cloud generator 110 may be used to add or remove characteristics for people 106. As another illustrative example, changes to the graphical display of words may be made for multiple people. Characteristics may also be displayed and manipulated for words in a word cloud that represents a group that has two or more people, or an entire organization. In yet another illustrative example, word clouds 300 also may include a word cloud that represents a task, a position, or some other suitable type of word cloud.

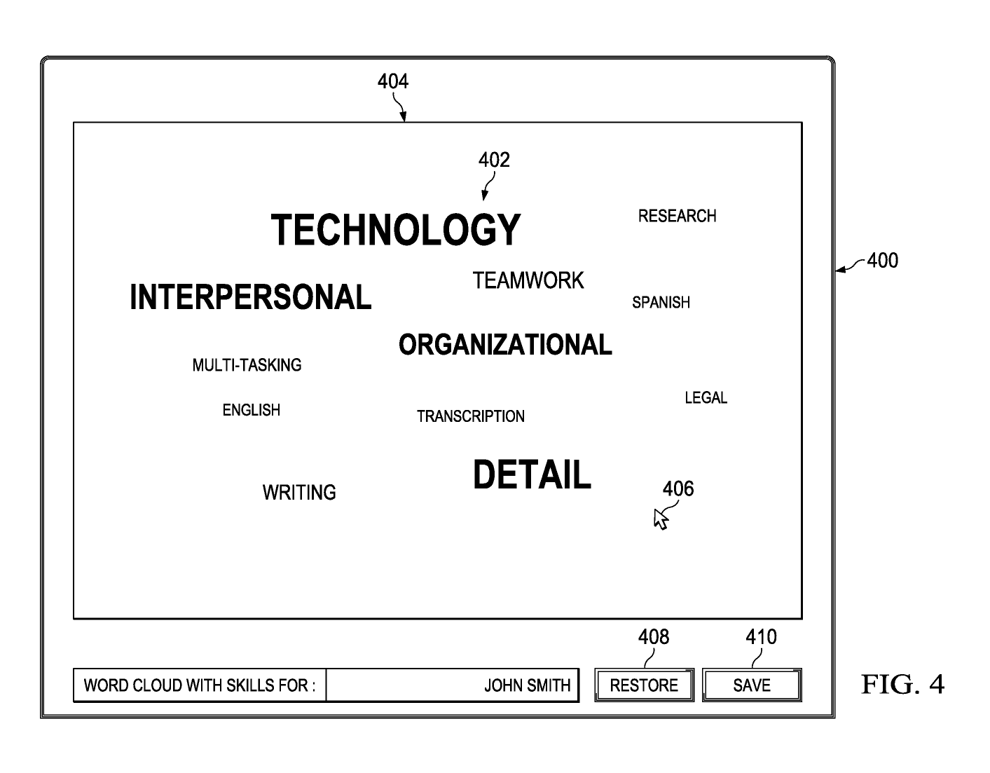

FIGS. 4-12 are illustrative examples of graphical user interfaces that may be used to interact with word cloud generator 110 to access characteristics of people through word clouds. With reference to FIG. 4, an illustration of a graphical user interface with a word cloud is depicted in accordance with an illustrative embodiment. Graphical user interface 400 is an example of one implementation for graphical user interface 125 shown in block form in FIG. 1.

In this illustrative example, words 402 are graphically displayed in word cloud 404. As depicted, word cloud 404 represents characteristics for a person. In particular, the characteristics are skills for a person named “John Smith”. As depicted, words 402 may be manipulated to change the values for skills represented by words 402 using pointer 406. Pointer 406 may be manipulated using an input device controlled by an operator.

In the illustrative example, changes may be undone using restore button 408. For example, a change to a size of a word in words 402 may be undone using restore button 408.

Further, changes may be saved using save button 410. Selecting save button 410 causes changes made in graphical user interface 400 to be saved in a database. In particular, changes to the size of one or more of words 402 indicated by pointer 406 causes changes in the values for those skills. These changed values are saved to the database when save button 410 is pushed by the operator.

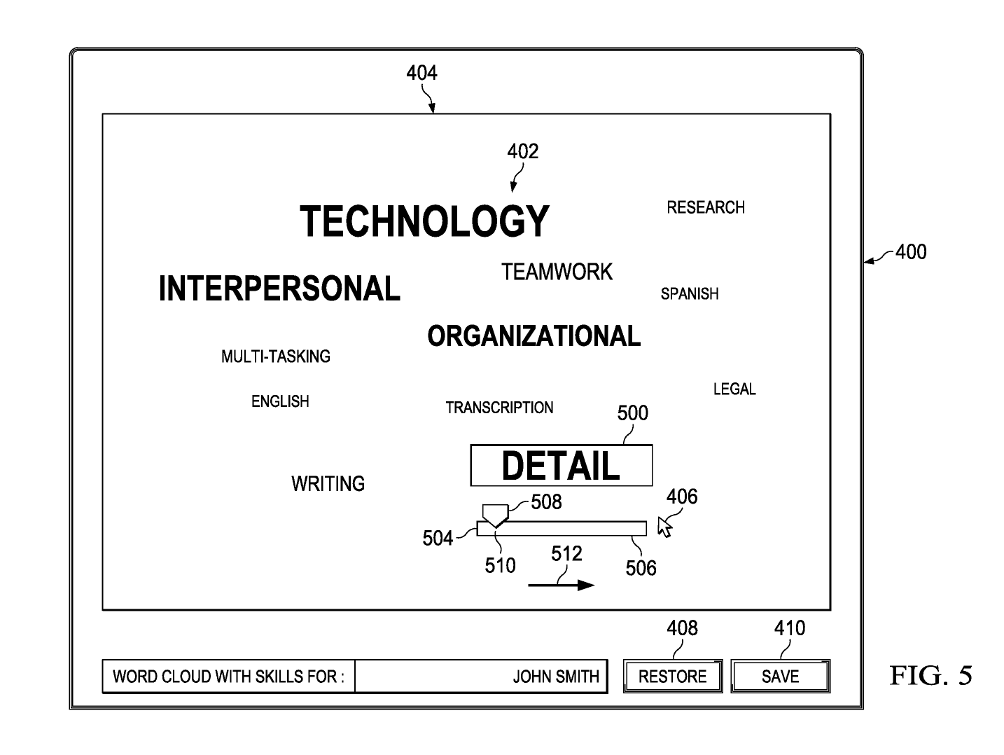

Turning next to FIG. 5, an illustration of a graphical user interface with a control to manipulate a word in a word cloud is depicted in accordance with an illustrative embodiment. In this illustrative example, DETAIL 500 is a word in words 402 selected using pointer 406 controlled by an operator.

Selection of DETAIL 500 results in control 504 being displayed in graphical user interface 400. Control 504 includes bar 506 and slider 508.

As depicted, a value for the skill, DETAIL 500, is indicated by slider 508 at position 510 on slider 508. The value for DETAIL 500 may be changed by moving slider 508 relative to bar 506. Moving slider 508 in the direction of arrow 512 from position 510 increases the value for DETAIL 500. Moving slider 508 in the opposite direction of arrow 512 from position 510 decreases the value for DETAIL 500.

In this manner, the graphical display of DETAIL 500 may be changed. In particular, the graphical display is a size of DETAIL 500 as graphically displayed in graphical user interface 400. In this manner, the value for DETAIL 500 is changed.

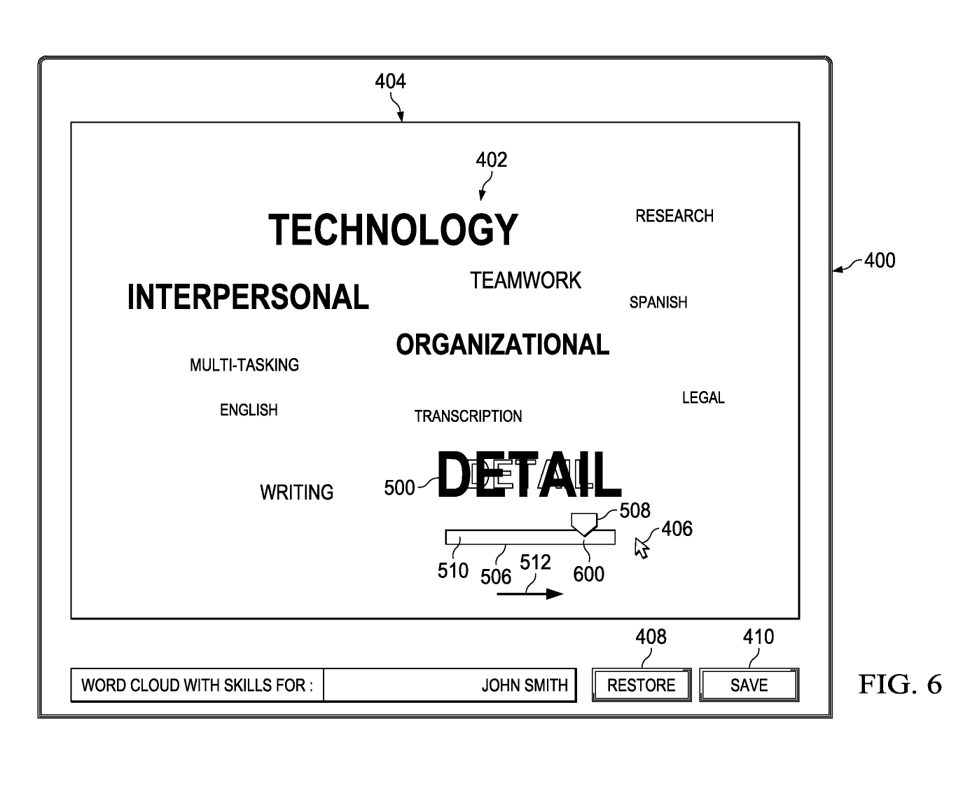

Turning next to FIG. 6, an illustration of a graphical user interface with a change in a graphical display of a word is depicted in accordance with an illustrative embodiment. As depicted in this example, slider 508 has been moved from position 510 in the direction of arrow 512 to position 600 on bar 506.

This movement of slider 508 changes the size of DETAIL 500. In particular, the size of DETAIL 500 is increased. This increase in size represents a visualization of the increase in the value of DETAIL 500. In this example, only the graphical display of DETAIL 500 changes. The graphical display of other words in words 402 remains the same in this particular example.

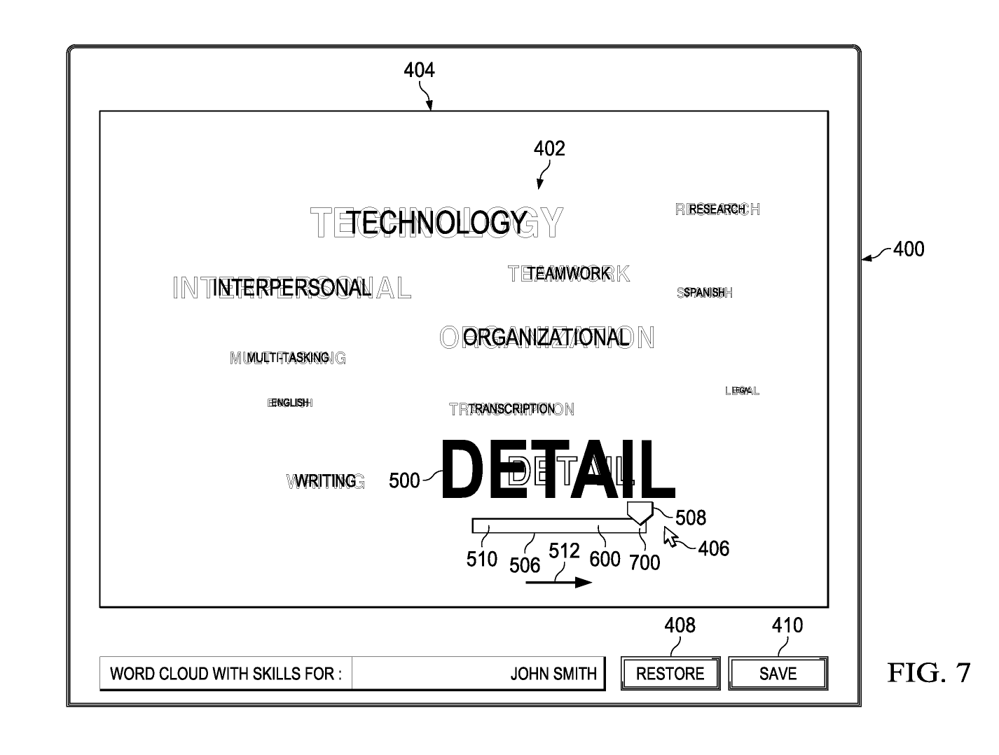

With reference now to FIG. 7, an illustration of a change in a graphical display of words in a word cloud is depicted in accordance with an illustrative embodiment. In this illustrative example, a total value is set for all of words 402. The total value is a sum of all of the values for words 402 in this example. As a result, changing the size of one word in words 402 results in changing the size of all of the other words in words 402. This change maintains the total value set for words 402.

As depicted, slider 508 has been moved from position 600 in the direction of arrow 512 to position 700 on bar 506. This movement of slider 508 to position 700 further increases the size of DETAIL 500.

In this example, the size of other words in words 402 also changes. The other words in words 402 decrease in size in response to an increase in the size of DETAIL 500. This change in the size of words is displayed to maintain the total value for words 402.

In another illustrative example, if the size of DETAIL 500 is reduced, the size of the other words in words 402 is increased. The change in the size of other words in words 402 is based on a proportion of each word in words 402 relative to the total value set for words 402.

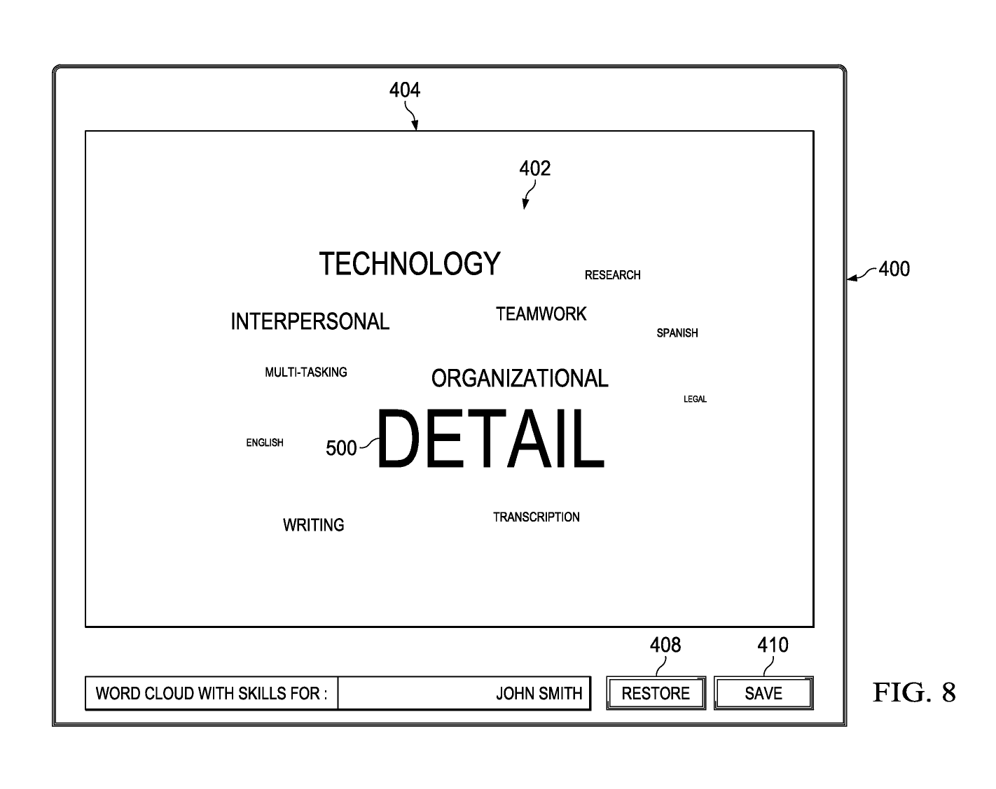

With reference now to FIG. 8, an illustration of a graphical user interface with a change in a graphical display of words in a word cloud is depicted in accordance with an illustrative embodiment. In this example, the location of different words in words 402 also may change in addition to increasing the size of DETAIL 500 in words 402 and decreasing the size of other words in words 402.

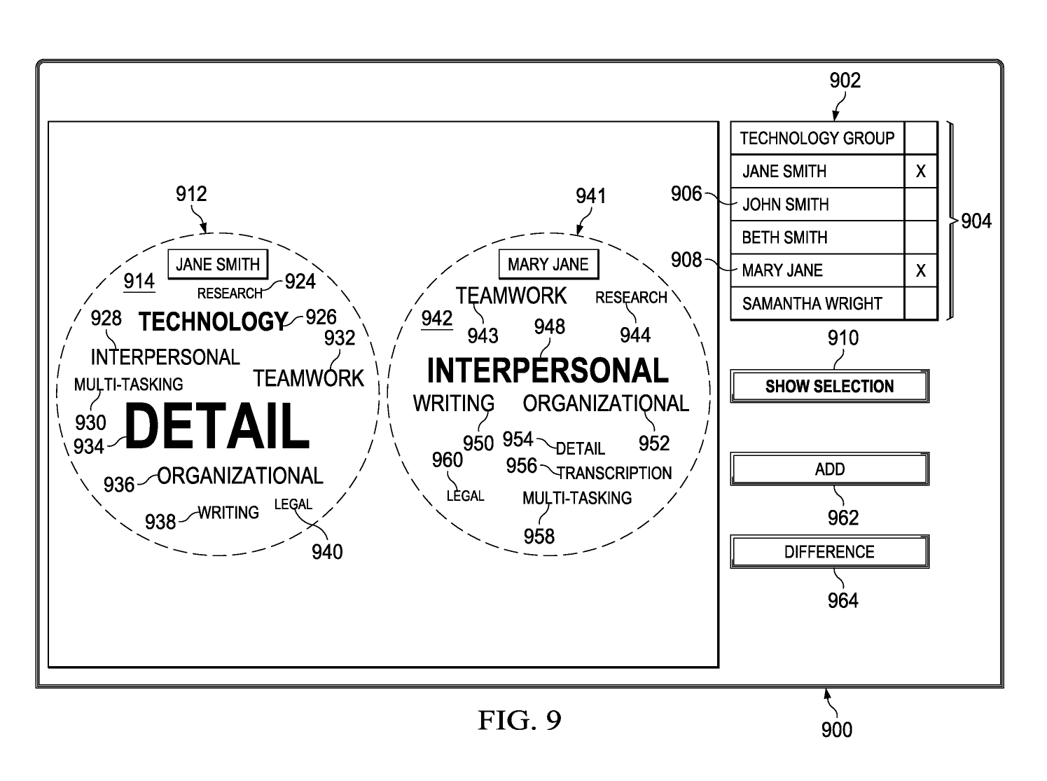

Turning next to FIG. 9, an illustration of a graphical user interface with word clouds for multiple people is depicted in accordance with an illustrative embodiment. In this illustrative example, graphical user interface 900 is an example of an implementation for graphical user interface 125 illustrated in block form in FIG. 1.

As depicted, graphical user interface 900 includes menu 902. Menu 902 displays people in entries 904 that may be selected within an organization. As depicted in graphical user interface 900, entry 906 and entry 908 in entries 904 have been selected. Additionally, show selection 910 button has been pushed.

As a result, word cloud 912 is displayed for entry 906 in graphical user interface 900. Words 914 in word cloud 912 represent characteristics in the form of skills for “Jane Smith” in this example. In this example, words 914 include RESEARCH 924, TECHNOLOGY 926, INTERPERSONAL 928, MULTI-TASKING 930, TEAMWORK 932, DETAIL 934, ORGANIZATIONAL 936, WRITING 938, and LEGAL 940.

Additionally, word cloud 941 is displayed for entry 908 in graphical user interface 900. Words 942 in word cloud 941 represent characteristics in the form of skills for “Mary Jane” in this depicted example. As depicted, words 942 include TEAMWORK 943, RESEARCH 944, INTERPERSONAL 948, WRITING 950, ORGANIZATIONAL 952, DETAIL 954, TRANSCRIPTION 956, MULTI-TASKING 958, and LEGAL 960.

In the illustrative example, a comparison of word clouds, such as word cloud 912 and word cloud 941, may be performed. The comparison may take different forms. For example, add button 962 and difference button 964 may be pushed to perform different types of comparisons. As depicted, add button 962 combines skills from selected word clouds. Difference button 964 identifies a difference between skills in the word clouds.

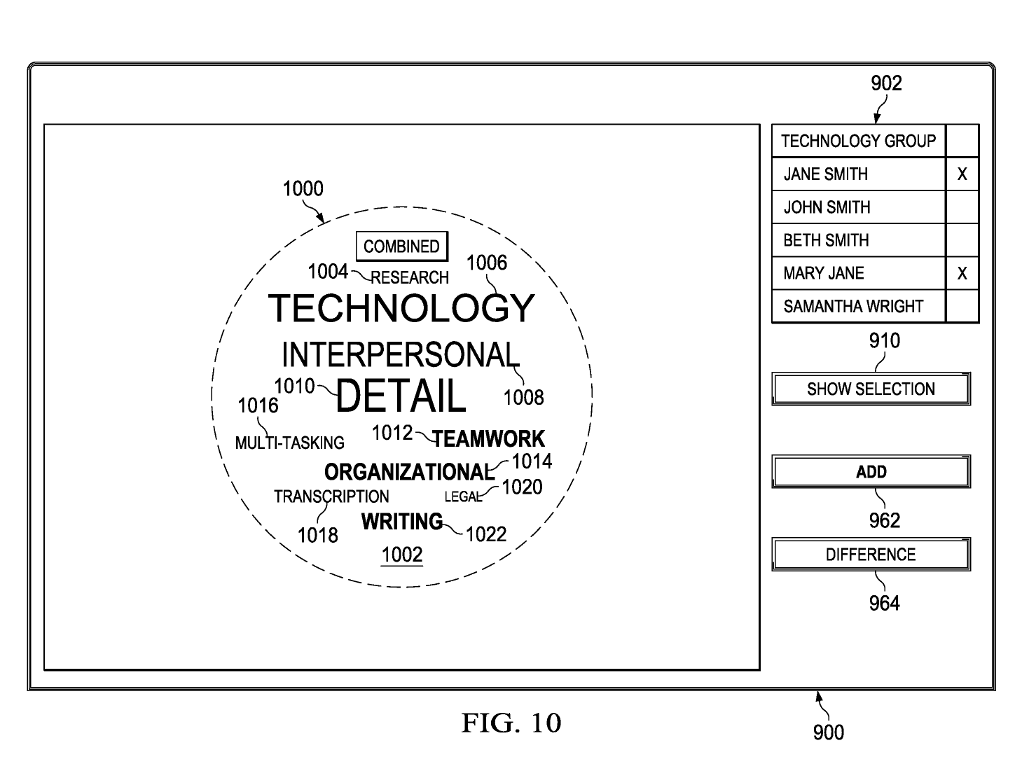

With reference to FIG. 10, an illustration of a graphical user interface in which skills in word clouds are combined is depicted in accordance with an illustrative embodiment. In this illustrative example, add button 962 in graphical user interface 900 has been pushed. This button causes the selected word clouds to be combined. In this illustrative example, word cloud 912 and word cloud 941 are combined to form word cloud 1000 with words 1002.

In this illustrative example, words 1002 in word cloud 1000 represent skills that are common to words 914 in word cloud 912 and words 942 in word cloud 941 in FIG. 9. As depicted, words 1002 include RESEARCH 1004, TECHNOLOGY 1006, INTERPERSONAL 1008, DETAIL 1010, TEAMWORK 1012, ORGANIZATIONAL 1014, MULTI-TASKING 1016, TRANSCRIPTION 1018, LEGAL 1020, and WRITING 1022.

The addition of the skills may be performed using a logic function. The identification of the skills may not include the value of the skills. If the values of the skills are included, the value for a particular skill that is present for both selections may be selected as the greatest value, lowest value, or an addition of values for the skill.

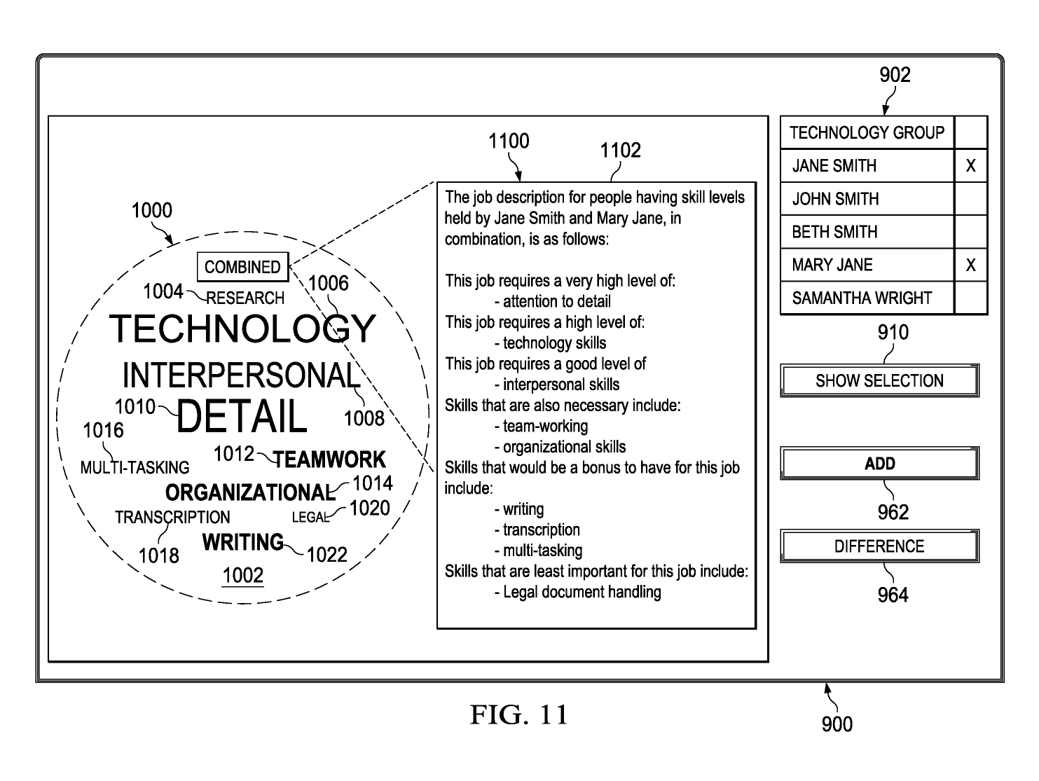

Turning next to FIG. 11, an illustration of a graphical user interface with a word cloud and a job description is depicted in accordance with an illustrative embodiment. In this example, job description 1100 in window 1102 in graphical user interface 900 is generated based on words 1002 in word cloud 1000. Job description 1100 may be used to fill a position within an organization. Job description 1100 also may be used to update a job description for an employee in the position or for some other suitable purpose in this illustrative example.

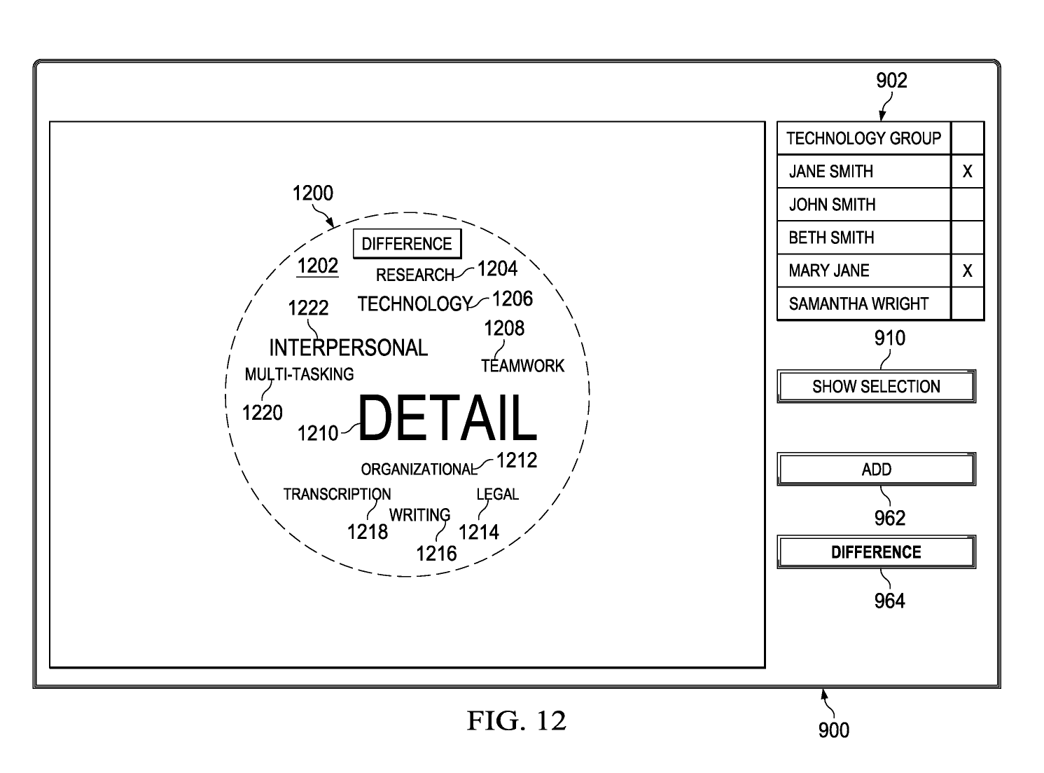

In FIG. 12, an illustration of a graphical user interface showing a word cloud generated from the difference between two word clouds is depicted in accordance with an illustrative embodiment. Word cloud 1200 in graphical user interface 900 includes words 1202. In this illustrative example, difference button 964 in graphical user interface 900 has been pushed. Pressing difference button 964 generates word cloud 1200 based on differences between selected word clouds.

In this illustrative example, word cloud 1200 is generated as the difference between words 914 in word cloud 912 and words 942 in word cloud 941 in FIG. 9. As depicted, words 1202 include RESEARCH 1204, TECHNOLOGY 1206, TEAMWORK 1208, DETAIL 1210, ORGANIZATIONAL 1212, LEGAL 1214, WRITING 1216, TRANSCRIPTION 1218, and MULTI-TASKING 1220.

The graphical display of words 1202 in this illustrative example is based on a difference between the values for words 914 and words 942 in FIG. 9. In particular, words 1202 have values that may be generated from a subtraction of values for words 914, and values for words 942. The subtraction may be performed as an absolute value of the difference between the values for the skills. In this illustrative example, the graphical display of words 1202 is based on the values identified for words 1202. If negative values are present, one color may be used to illustrate positive values and another color to illustrate negative values.

In this illustrative example, the size for a word in words 1202 in word cloud 1200 increases as the difference between the values for the corresponding words in word cloud 912 and word cloud 941 in FIG. 9 increases. For example, the greatest difference between words in word cloud 912 and word cloud 941 is for DETAIL 1210. As depicted, DETAIL 934 for Jane Smith and DETAIL 954 for Mary Jane have the greatest difference in size as compared to other words in these word clouds. As a result, the difference in values is greater as compared to other words. This difference is the greatest difference as illustrated in the size of DETAIL 1210 in word cloud 1200.

The illustration of the word clouds in the graphical user interfaces in FIGS. 4-12 are not meant to imply limitations to the manner in which other illustrative examples may be implemented. For example, in other illustrative examples, three or more word clouds display a graphical user interface when three or more people are selected in the menu. In yet another illustrative example, a difference between skills or a combination of skills may be performed by selecting people from menu 902 and then selecting add button 962 or difference button 964. The resulting word cloud comparison may be displayed without displaying the word clouds for the people selected from menu 902.

In yet another illustrative example, the graphical display of the words may be performed using other graphical indicators other than a size of the words. For example, color, shading, font, or other graphical indicators may be used to indicate the values for the words. A number may be displayed by the word to indicate the value. A grayscale may be used to indicate the value. For example, a darker shade indicates a larger value as compared to a lighter shade when a grayscale is used to display words.

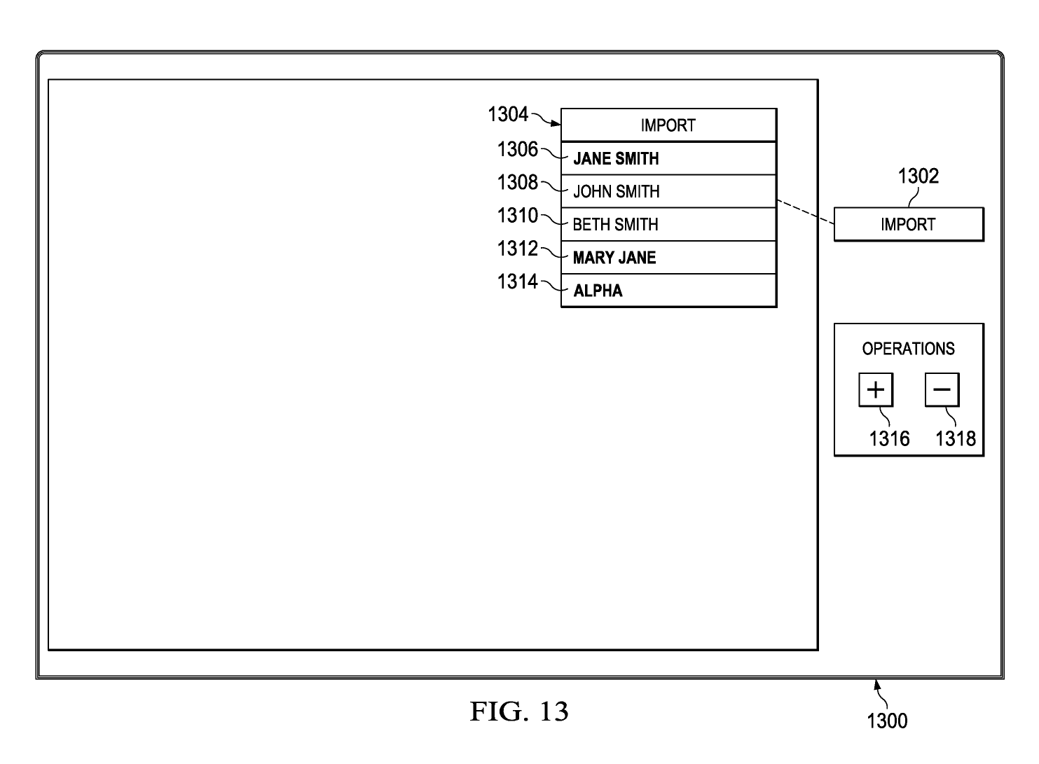

FIGS. 13-18 illustrate the display of information in word clouds from the manipulation of word clouds. The different manipulations illustrated in these figures are performed by word cloud generator 110. These manipulations may include importing word clouds for display, performing functions using the word clouds displayed, and other suitable types of manipulations. In this manner, an operator may manipulate word clouds to interact with each other as shown in FIGS. 13-18. The results of this manipulation may allow an operator to more efficiently perform tasks involving people in an organization.

Turning now to FIG. 13, an illustration of a graphical user interface for importing word clouds is depicted in accordance with an illustrative embodiment. Graphical user interface 1300 is another example of an implementation for graphical user interface 125 shown in block form in FIG. 1.

In this illustrative example, word clouds may be imported using import button 1302. As used herein, importing data bring the data for use into graphical user interface 1300. For example, importing a word cloud into graphical user interface 1300 brings words for the word cloud into graphical user interface 1300 for display in a graphical manner.

In this illustrative example, word cloud generator 110 brings word clouds into graphical user interface 1300 by displaying the word clouds in graphical user interface 1300. Word cloud generator 110 displays word clouds in graphical interface 1300 in a format for display as determined by word cloud generator 110. For example, the format for display of words in word clouds may include displaying the words using at least one of a size, font, color, animation, or some other suitable parameter for graphically displaying words.

As depicted, import window 1304 is displayed when import button 1302 is selected by user input. In this illustrative example, import window 1304 receives user input to select word clouds for display. The word clouds may be for at least one of a project, a person, resources, or some other suitable type of word cloud.

In this illustrative example, the word clouds that may be selected in import window 1304 include word clouds for JANE SMITH 1306, JOHN SMITH 1308, BETH SMITH 1310, and MARY JANE 1312. These entries are for word clouds that represent people. As depicted, import window 1304 also includes ALPHA 1314, which represents a word cloud for a project. In this example, user input has been received in import window 1304 for importing word clouds for JANE SMITH 1306, MARY JANE 1312, and ALPHA 1314.

In this illustrative example, graphical user interface 1300 also includes addition button 1316 and subtract button 1318. As depicted, addition button 1316 is displayed as a “+” function. In this illustrative example, selecting addition button 1316 performs an addition function on word clouds. Subtract button 1318 is displayed as a “−” function. Selecting subtract button 1318 performs a subtraction function on word clouds.

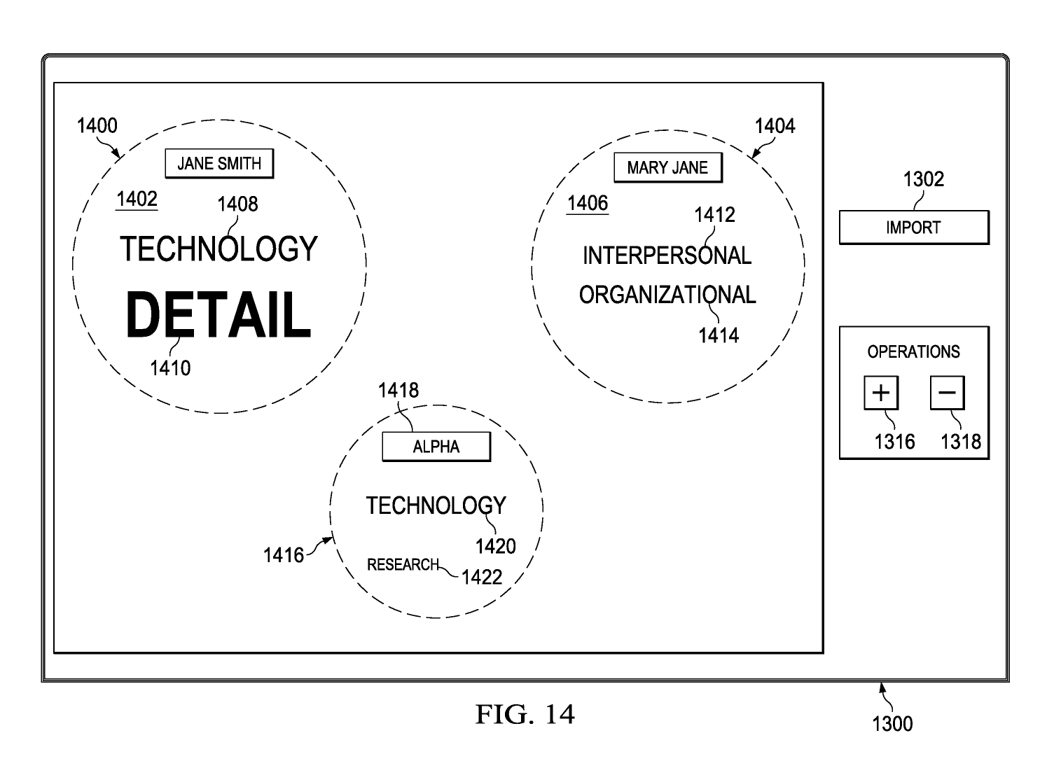

Turning next to FIG. 14, an illustration of a graphical user interface displaying word clouds that have been imported is depicted in accordance with an illustrative embodiment. As depicted, graphical user interface 1300 includes word cloud 1400 for employee JANE SMITH 1402 and word cloud 1404 for employee MARY JANE 1406. The words in word cloud 1400 and word cloud 1404 show skills for the respective employees. In this illustrative example, word cloud 1400 includes TECHNOLOGY 1408 and DETAIL 1410. Word cloud 1404 includes INTERPERSONAL 1412 and ORGANIZATIONAL 1414. As depicted, graphical user interface 1300 also includes word cloud 1416 for project ALPHA 1418. In this illustrative example, word cloud 1416 includes TECHNOLOGY 1420 and RESEARCH 1422. In this illustrative example, import button 1302 has been used to import word cloud 1400 for employee JANE SMITH 1402, word cloud 1404 for employee MARY JANE 1406, and word cloud 1416 for project ALPHA 1418.

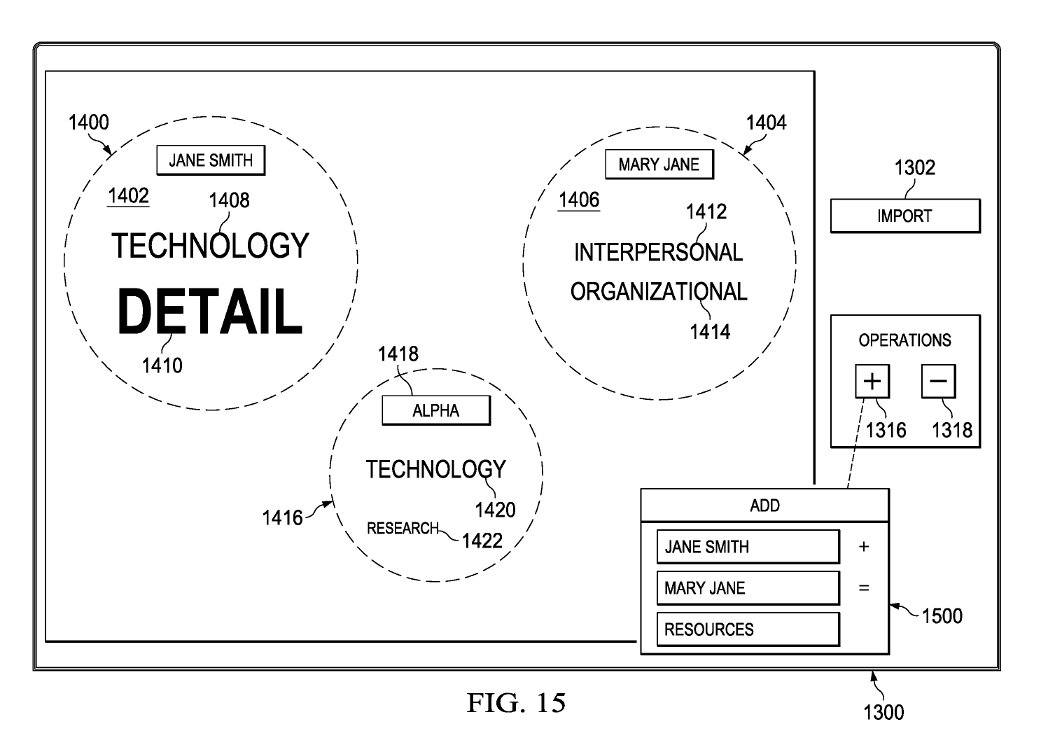

With reference to FIG. 15, an illustration of a graphical user interface for performing functions on word clouds is depicted in accordance with an illustrative embodiment. In this illustrative example, user input has been received selecting addition button 1316. Add window 1500 is displayed when addition button 1316 is selected in this illustrative example.

As depicted, user input has been received in graphical user interface 1300 for performing an addition function on word cloud 1400 for employee JANE SMITH 1402 and word cloud 1404 for employee MARY JANE 1406. In particular, user input has been received for selecting to add word cloud 1400 for employee JANE SMITH 1402 to word cloud 1404 for employee MARY JANE 1406 and store the results in a word cloud for RESOURCES, not shown in graphical user interface 1300 in this figure.

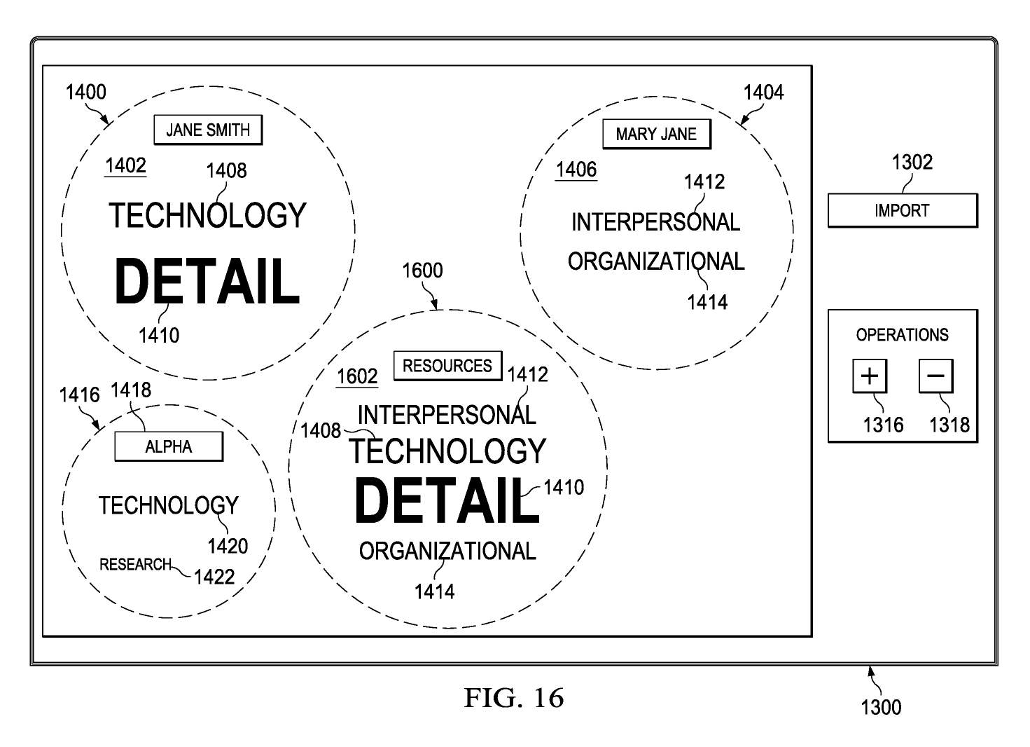

With reference next to FIG. 16, an illustration of a graphical user interface displaying a word cloud generated from a function performed on word clouds is depicted is depicted in accordance with an illustrative embodiment. As depicted, graphical user interface 1300 includes word cloud 1600 for RESOURCES 1602 as generated by the addition of word cloud 1400 and word cloud 1404 in FIG. 15.

In this illustrative example, word cloud 1600 is generated based on the user input received in add window 1500 in FIG. 15. In particular, word cloud 1600 for RESOURCES 1602 is the result of adding word cloud 1400 for employee JANE SMITH 1402 to word cloud 1404 for employee MARY JANE 1406. In this illustrative example, word cloud 1600 for RESOURCES 1602 includes TECHNOLOGY 1408, DETAIL 1410, INTERPERSONAL 1412, and ORGANIZATIONAL 1414.

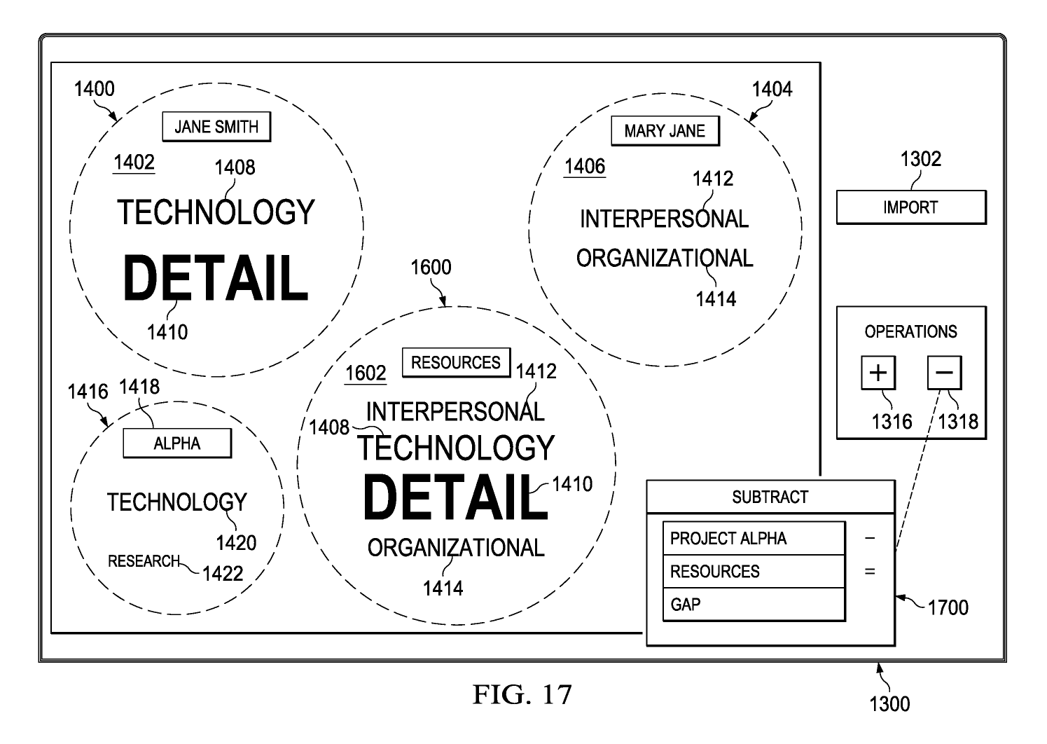

With reference now to FIG. 17, an illustration of a graphical user interface for performing functions on word clouds is depicted in accordance with an illustrative embodiment. In this illustrative example, user input has been received selecting subtract button 1318. Subtract window 1700 is displayed when subtract button 1318 is selected in this illustrative example.

As depicted, user input has been received in graphical user interface 1300 for performing a subtraction function on word cloud 1416 for project ALPHA 1418 and word cloud 1600 for RESOURCES 1602. In particular, user input has been received for selecting to subtract word cloud 1600 for RESOURCES 1602 from word cloud 1416 for project ALPHA 1418 and store the results in a word cloud named GAP, not shown in graphical user interface 1300 in this figure.

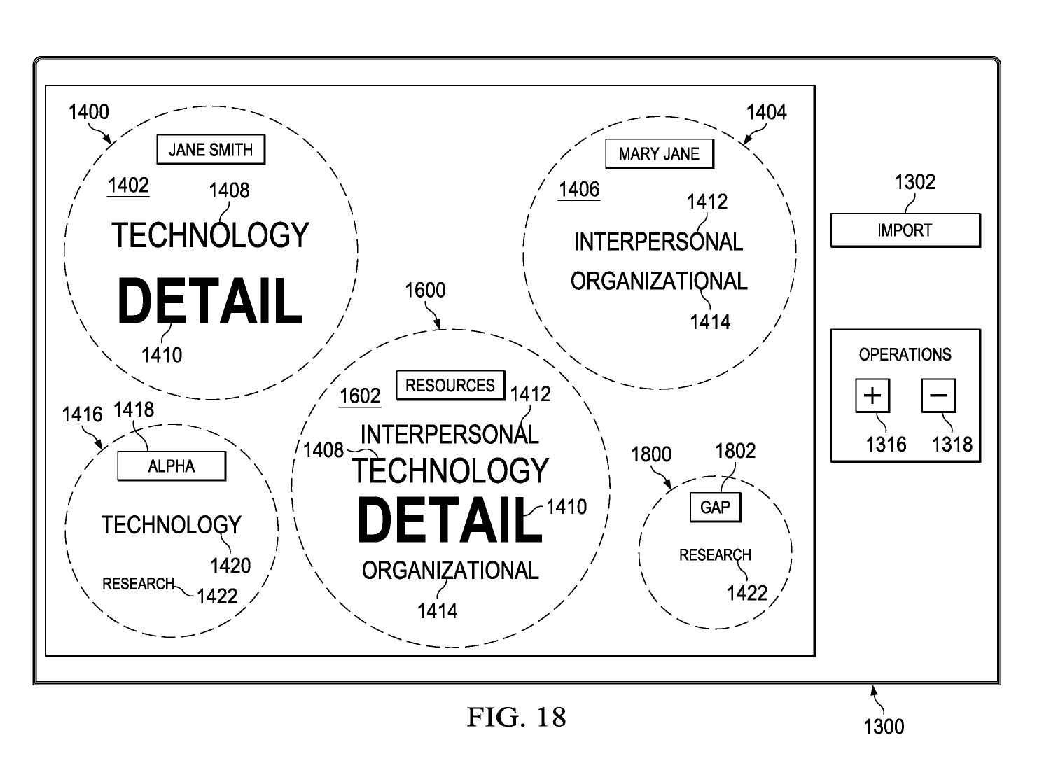

Turning to FIG. 18, an illustration of a graphical user interface displaying a word cloud generated from a function performed on word clouds is depicted in accordance with an illustrative embodiment. As depicted, graphical user interface 1300 includes word cloud 1800 for GAP 1802.

In this illustrative example, word cloud 1800 is based on the user input received in subtract window 1700 in FIG. 17. In particular, word cloud 1800 for GAP 1802 is the result of subtracting word cloud 1600 for RESOURCES 1602 from word cloud 1416 for project ALPHA 1418. In this illustrative example, word cloud 1800 for GAP 1802 includes RESEARCH 1422. In this manner, a gap in skills needed for a particular project may be identified as shown in FIGS. 13-18.

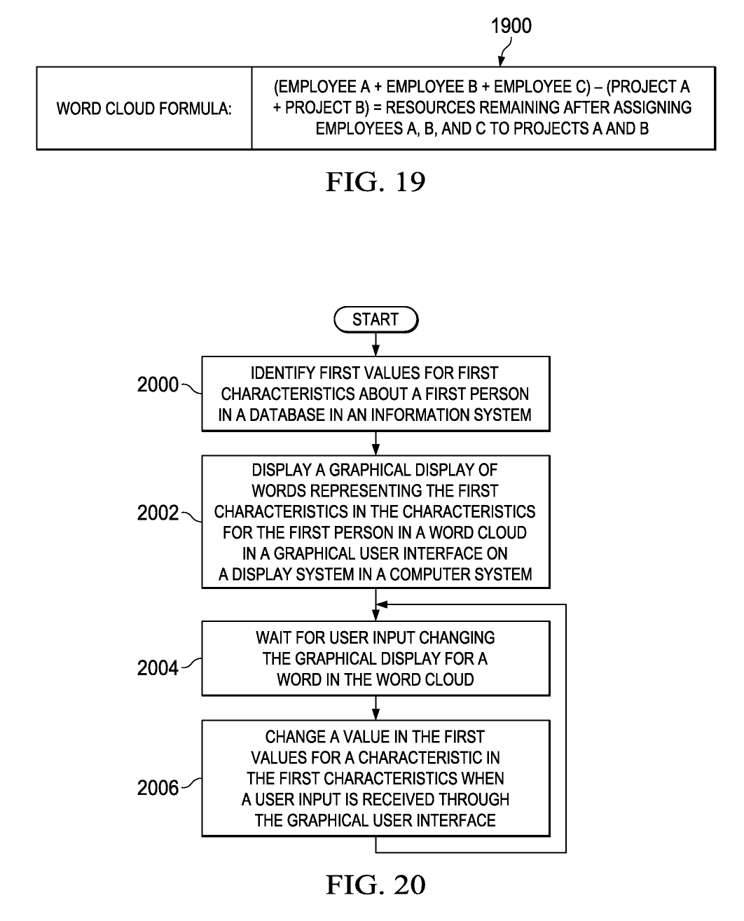

Turning now to FIG. 19, an illustration of a graphical user interface for defining one or more functions to perform on word clouds is depicted in accordance with an illustrative embodiment. In some implementations, the different manipulations of word clouds may be entered as an equation. In this example, entry field 1900 is an example of a field that may be used to receive an equation identifying manipulations of word clouds. These manipulations may include performing one or more functions using one or more word clouds in the illustrative examples.

In this illustrative example, entry field 1900 shows user input for performing a function with an equation as follows:

(EMPLOYEE A+EMPLOYEE B+EMPLOYEE C)−(PROJECT A+PROJECT B)=RESOURCES REMAINING AFTER ASSIGNING EMPLOYEES A, B, AND C TO PROJECTS A AND B

EMPLOYEE A, EMPLOYEE B, EMPLOYEE C, PROJECT A, AND PROJECT B are word clouds. In this illustrative example, the result of the function is stored in a word cloud named “RESOURCES REMAINING AFTER ASSIGNING EMPLOYEES A, B, AND C TO PROJECTS A AND B.”

The illustration of a graphical user interface in FIGS. 13-18 and the entry field in FIG. 19 are not meant to imply limitations the manner in which different illustrative examples may be implemented. For example, other numbers of word clouds may be imported and manipulated. For example, two or more projects may be evaluated for skill gaps instead of the single project in the illustrative example using FIGS. 13-19.

As a result, an operator may more efficiently perform tasks in an organization. For example, the operator may more efficiently identify persons needed for projects. In another illustrative example, an operator may identify what projects may be performed by the organization based on resources available. For example, an operator may choose to bid on or select one project over another project based on resources identified as being available for performing projects. With the visualization of at least one of resources or skill gaps, an operator may select projects, hire personnel, shift personnel, or perform other tasks more efficiently than without an illustrative embodiment.

Turning next to FIG. 20, an illustration of a flowchart of a process for managing characteristics in word clouds is depicted in accordance with an illustrative embodiment. The process illustrated in FIG. 20 may be implemented in information environment 100 in FIG. 1. In particular, the process may be implemented in word cloud generator 110 in information system 102 in FIG. 1.

The process begins by identifying first values for first characteristics about a first person in a database in an information system (operation 2000). The process then displays a graphical display of words representing the first characteristics in the characteristics for the first person in a word cloud in a graphical user interface on a display system in a computer system (operation 2002). The graphical display of the words represents first characteristics with first values that distinguish the first person from a second person with second characteristics with second values.

The process waits for user input changing the graphical display for a word in the word cloud (operation 2004). When user input is received changing the graphical display of the word, the process changes a value in the first values for a characteristic in the first characteristics when a user input is received through the graphical user interface (operation 2006) with the process then returning to operation 2004. The user input changes the graphical display of a word in the words corresponding to the characteristic.

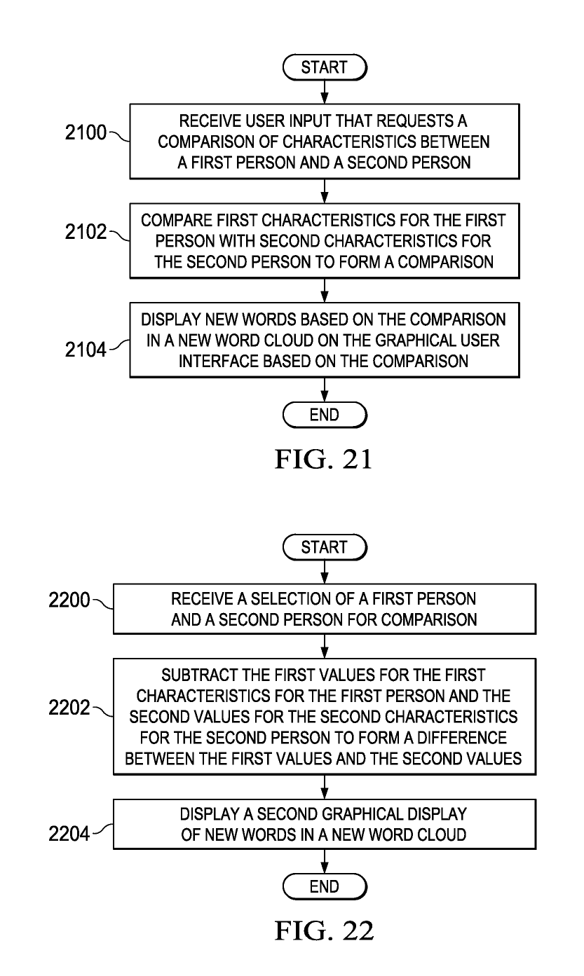

Turning to FIG. 21, an illustration of a flowchart of a process for performing a comparison of characteristics between two people is depicted in accordance with an illustrative embodiment. The process in FIG. 21 may be implemented in word cloud generator 110 in information environment 100 in FIG. 1.

The process begins by receiving user input that requests a comparison of characteristics between a first person and a second person (operation 2100). The process compares first characteristics for the first person with second characteristics for the second person to form a comparison (operation 2102). The process then displays new words based on the comparison in a new word cloud on the graphical user interface (operation 2104) with the process terminating thereafter.

With reference next to FIG. 22, an illustration of a flowchart of a process for performing a comparison of skills is depicted in accordance with an illustrative embodiment. In this example, the process may be implemented in word cloud generator 110 in information environment 100 in FIG. 1.

The process begins by receiving a selection of a first person and a second person for comparison (operation 2200). The selection may be made in a number of different ways. For example, the persons may be selected from a list in a menu such as a window displayed in a graphical user interface. In another illustrative example, the function may be made by dragging a word cloud from one person and dropping the word cloud on a word cloud for another person.

The process subtracts the first values for the first characteristics for the first person and the second values for the second characteristics for the second person to form a difference between the first values and the second values (operation 2202). In operation 2202, the difference forms a comparison of the first characteristics and the second characteristics.

The process then displays a second graphical display of new words in a new word cloud (operation 2204) with the process terminating thereafter. The second graphical display of the new words represents a difference between the first values for the first characteristics for the first person and the second values for the second characteristics for the second person.

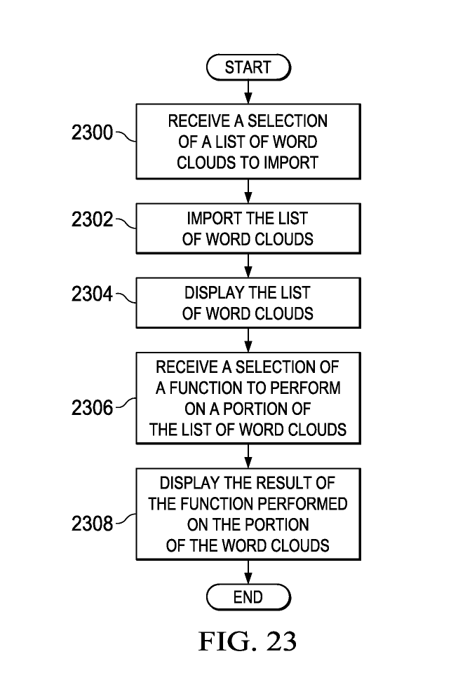

With reference next to FIG. 23, an illustration of a flowchart of a process for performing functions on word clouds is depicted in accordance with an illustrative embodiment. In this example, the process may be implemented in word cloud generator 110 in information environment 100 in FIG. 1. In particular the process may be implemented in word cloud generator 110 using graphical user interface 125 shown in block form in FIG. 1. These functions may be performed to cause interactions between word clouds. These interactions may result in one or more word clouds being formed based on the interactions selected.

The process begins by receiving a selection of a list of word clouds to import (operation 2300). As used herein, a “list of” when used with reference to items means one or more items. For example, the list of word clouds is one or more word clouds. In this process, the selection of the list of word clouds may be based on user input sent to graphical user interface 1300 in FIG. 13.

The process next imports the list of word clouds (operation 2302). The process then displays the list of word clouds (operation 2304).

The process next receives a selection of a function to perform on a portion of the list of word clouds (operation 2306). The process then displays the result of the function performed on the portion of the word clouds (operation 2308) with the process terminating thereafter.

In this manner, an operator may use the visualization of the result to identify results such as skill gaps. In one illustrative example, the skill gaps may be used identify whether additional persons are needed for a particular project. Additionally, the results of the function may also be used to generate a job description for a person, when the consolidation of positions occurs. These and other tasks may be performed using the visualization of word clouds that are manipulated to interact with each other in a graphical user interface to generate a result. As result, an operator may more efficiently perform a task based on the visualization of the results of the manipulation of word clouds in a graphical user interface.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

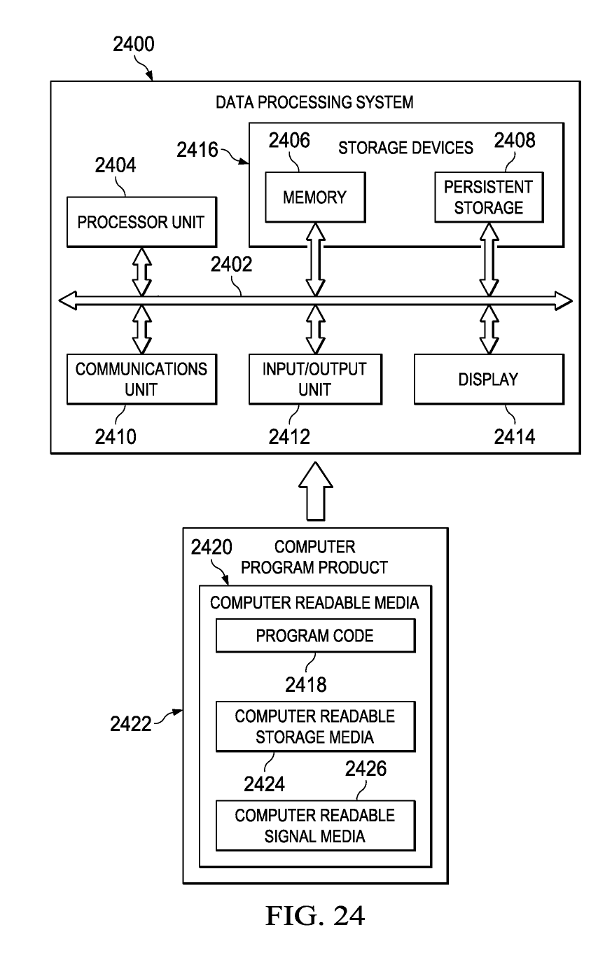

Turning now to FIG. 24, an illustration of a block diagram of a data processing system is depicted in accordance with an illustrative embodiment. Data processing system 2400 may be used to implement one or more data processing systems in computer system 114 in FIG. 1. In this illustrative example, data processing system 2400 includes communications framework 2402, which provides communications between processor unit 2404, memory 2406, persistent storage 2408, communications unit 2410, input/output (I/O) unit 2412, and display 2414. In this example, communication framework may take the form of a bus system.

Processor unit 2404 serves to execute instructions for software that may be loaded into memory 2406. Processor unit 2404 may be a number of processors, a multi-processor core, or some other type of processor, depending on the particular implementation.

Memory 2406 and persistent storage 2408 are examples of storage devices 2416. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2416 may also be referred to as computer readable storage devices in these illustrative examples. Memory 2406, in these examples, may be, for example, a random access memory or any other suitable volatile or non-volatile storage device. Persistent storage 2408 may take various forms, depending on the particular implementation.

For example, persistent storage 2408 may contain one or more components or devices. For example, persistent storage 2408 may be a hard drive, a flash memory, a rewritable optical disk, a rewritable magnetic tape, or some combination of the above. The media used by persistent storage 2408 also may be removable. For example, a removable hard drive may be used for persistent storage 2408.

Communications unit 2410, in these illustrative examples, provides for communications with other data processing systems or devices. In these illustrative examples, communications unit 2410 is a network interface card.

Input/output unit 2412 allows for input and output of data with other devices that may be connected to data processing system 2400. For example, input/output unit 2412 may provide a connection for user input through at least of a keyboard, a mouse, or some other suitable input device. Further, input/output unit 2412 may send output to a printer. Display 2414 provides a mechanism to display information to a user.

Instructions for at least one of the operating system, applications, or programs may be located in storage devices 2416, which are in communication with processor unit 2404 through communications framework 2402. The processes of the different embodiments may be performed by processor unit 2404 using computer-implemented instructions, which may be located in a memory, such as memory 2406.

These instructions are referred to as program code, computer usable program code, or computer readable program code that may be read and executed by a processor in processor unit 2404. The program code in the different embodiments may be embodied on different physical or computer readable storage media, such as memory 2406 or persistent storage 2408.

Program code 2418 is located in a functional form on computer readable media 2420 that is selectively removable and may be loaded onto or transferred to data processing system 2400 for execution by processor unit 2404. Program code 2418 and computer readable media 2420 form computer program product 2422 in these illustrative examples. In one example, computer readable media 2420 may be computer readable storage media 2424 or computer readable signal media 2426.

In these illustrative examples, computer readable storage media 2424 is a physical or tangible storage device used to store program code 2418 rather than a medium that propagates or transmits program code 2418. Alternatively, program code 2418 may be transferred to data processing system 2400 using computer readable signal media 2426. Computer readable signal media 2426 may be, for example, a propagated data signal containing program code 2418. For example, computer readable signal media 2426 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 2400 are not meant to provide architectural limitations to the manner in which different embodiments may be implemented. The different illustrative embodiments may be implemented in a data processing system including components in addition to or in place of those illustrated for data processing system 2400. Other components shown in FIG. 24 can be varied from the illustrative examples shown. The different embodiments may be implemented using any hardware device or system capable of running program code 2418.

Thus, the illustrative embodiments provide a method and apparatus for managing characteristics of people graphically displayed in word clouds in a graphical user interface in a computer system. In one illustrative example, user input may change a graphical display of a word in words displayed in a word cloud. The change is a change in the size of the word in one illustrative example. The change in the size causes the value of the characteristic to change. The change in the sizes provides a visualization of the relative value of one characteristic with respect to other characteristics displayed in the word cloud. The changes made by user input allows for a visualization of changes that may increase the ease at which characteristics for people may be changed or compared.

In this manner, the management of projects, employees, and other operations may be made more easily as compared to currently used techniques. For example, a job requirement skills list can be represented in a word cloud for a particular job. Skills for an employee in the job are also represented in a word cloud generated using the job requirement skills word cloud and an employee skills word cloud. Subtraction of these two word clouds may be performed after standardizing both word clouds to the same number of skills. The subtraction of these two work clouds may identify employee skills gaps for future education development, unused skills available for future projects, or other purposes.

For example, when a new position needs to be selected or filled, word clouds with skills for existing employees may be used to generate a customized job description. For example, a new employee may be selected as follows: New Employee=(Standard Skills−Employee A)+Employee B. The use of word clouds as described above allows finding a candidate who is like employee B but also has an emphasis on skill gaps for employee A. The search to fill a position also may be for a new employee as follows: New Employee=Employee A+Employee B. The word cloud generator may be used to find someone who has skills for both employee A and employee B. These and other operations may be performed using a cloud generator in the illustrative examples.

The description of the different illustrative embodiments has been presented for purposes of illustration and description, and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. In particular, word cloud generator is configured to perform the different operations described as well as other operations using at least one of program code, hardware, firmware, or other suitable components.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for managing characteristics in word clouds, the method comprising:
displaying, by a computer system, a graphical display of words representing first characteristics in the characteristics for a first person in a word cloud in a graphical user interface on a display system in the computer system, wherein the graphical display of the words represents the first characteristics with first values that distinguish the first person from a second person with second characteristics with second values; and
changing, by the computer system, a value in the first values for a characteristic in the first characteristics when a user input is received through the graphical user interface in which the user input changes the graphical display of a word in the words corresponding to the characteristic.

2. The method of claim 1 further comprising:
identifying, by the computer system, the first values for the first characteristics about the first person in a database in an information system.

3. The method of claim 1 further comprising:
changing the graphical display of the words for the first person to reflect a change in the first values for the first characteristics.

4. The method of claim 1 further comprising:
changing values based on a change in the value such that a total of the values remains unchanged when the value is changed.

5. The method of claim 1 further comprising:
receiving the user input that requests a comparison of the characteristics between the first person and the second person;
comparing the first characteristics for the first person with the second characteristics for the second person to form the comparison; and
displaying new words based on the comparison in a new word cloud based on the comparison.

6. The method of claim 5, wherein comparing the first characteristics for the first person with the second characteristics for the second person to form the comparison comprises:
subtracting the first values for the first characteristics for the first person and the second values for the second characteristics for the second person to form a difference between the first values and the second values; and
wherein displaying the new words based on the comparison in the new word cloud based on the comparison comprises:
displaying a second graphical display of the new words in the new word cloud, wherein the second graphical display of the new words represent the difference between the first values for the first characteristics for the first person and the second values for the second characteristics for the second person.

7. The method of claim 1, wherein the user input changes at least one of a size, an animation, a color, or a font for the word.

8. The method of claim 1, wherein the characteristics are selected from at least one of a skill, an education level, an interest, a tenure, a name, a work location, or a competency.

9. A computer system comprising:
a display system; and
a word cloud generator in the computer system in communication with the display system, wherein the word cloud generator displays a graphical display of words representing first characteristics in characteristics for a first person in a word cloud in a graphical user interface on the display system in the computer system, wherein the graphical display of the words represents the first characteristics with first values that distinguish the first person from a second person with second characteristics with second values and changes a value in the first values for a characteristic in the first characteristics when a user input is received through the graphical user interface in which the user input changes the graphical display of a word in the words corresponding to the characteristic.

10. The computer system of claim 9, wherein the word cloud generator identifies the first values for the first characteristics about the first person in a database in an information system.

11. The computer system of claim 9, wherein the word cloud generator changes the graphical display of the words for the first person to reflect a change in the first values for the first characteristics.

12. The computer system of claim 9, wherein the word cloud generator changes values based on a change in the value such that a total of the values remains unchanged when the value is changed.

13. The computer system of claim 9, wherein the word cloud generator receives the user input that requests a comparison of the characteristics between the first person and the second person; compares the first characteristics for the first person with the second characteristics for the second person to form the comparison; and displays new words based on the comparison in a new word cloud based on the comparison.

14. The computer system of claim 13, wherein in comparing the first characteristics for the first person with the second characteristics for the second person to form the comparison comprises:
subtracting, by the word cloud generator, the first values for the first characteristics for the first person and the second values for the second characteristics for the second person to form a difference between the first values for the first characteristics for the first person and the second values for the second characteristics for the second person; and wherein in displaying the new words based on the comparison in the new word cloud based on the comparison, the word cloud generator displays a second graphical display of the new words in the new word cloud, wherein the second graphical display of the new words represents the difference between the first values for the first characteristics for the first person and the second values for the second characteristics for the second person.

15. The computer system of claim 9, wherein the user input changes at least one of a size, an animation, a color, or a font for the word.

16. The computer system of claim 9, wherein the characteristics are selected from at least one of a skill, an education level, an interest, a tenure, a name, a work location, or a competency.

17. A computer program product for managing characteristics in word clouds, the computer program product comprising:
a computer readable storage media;
first program code, stored on the computer readable storage media, for displaying a graphical display of words representing first characteristics in the characteristics for a first person in a word cloud in a graphical user interface on a display system in a computer system, wherein the graphical display of the words represents the first characteristics with first values that distinguish the first person from a second person with second characteristics with second values; and
second program code, stored on the computer readable storage media, for changing a value in the first values for a characteristic in the first characteristics when a user input is received through the graphical user interface in which the user input changes the graphical display of a word in the words corresponding to the characteristic.

18. The computer program product of claim 17 further comprising:
third program code, stored on the computer readable storage media, for identifying the first values for the first characteristics about the first person in a database in an information system.

19. The computer program product of claim 17 further comprising:
third program code, stored on the computer readable storage media, for changing the graphical display of the words for the first person to reflect a change in the first values for the first characteristics.

20. The computer program product of claim 17 further comprising:
third program code, stored on the computer readable storage media, for changing values based on a change in the value such that a total of the values remains unchanged when the value is changed.
